(19) United States
(12) Patent Application Publication
(10) Pub. No.: US 2026/0302613 A1
(43) Pub. Date: Oct. 1, 2026

(54) CONTROL UNIT AND METHOD FOR TRIGGERING BEAMSTEERING OF A RADIO COMMUNICATION ANTENNA

(71) Applicant: Telefonaktiebolaget LM Ericsson (publ), Stockholm (SE)

(72) Inventors: Sam AGNEESSENS, Torslanda (SE); Christoffer FOUGSTEDT, Göteborg (SE); Giuseppe MOSCHETTI, Mölndal (SE); Henric BROSTRÖM, Fjärås (SE)

(73) Assignee: Telefonaktiebolaget LM Ericsson (publ), Stockholm (SE)

(21) Appl. No.: 19/478,003

(22) PCT Filed: Apr. 28, 2023
(86) PCT No.: PCT/EP2023/061401

§ 371 Date: Oct. 23, 2025

(51) Int. Cl. H01Q 3/34; H04B 7/06

(52) U.S. Cl. CPC H01Q 3/34; H04B 7/0617

(57) ABSTRACT

The present disclosure relates to a computer-implemented method performed by a control unit (1000) for triggering beamsteering of a radio communication antenna (105) mounted to a mounting structure (113). The control unit (1000) obtains a motion signal indicating movement of the antenna (105). The control unit (1000) generates a compensation signal based on the motion signal. The compensation signal is in-phase with the motion signal. The control unit (1000) riggers beamsteering of the radio communication antenna (105) using the compensation signal, thereby compensating the movement of the antenna (105).

### TECHNICAL FIELD

The present disclosure relates generally to a control unit, a computer-implemented method performed by the control unit, a radio communication antenna, a computer program product and a non-transitory computer-readable storage medium. More particularly, the present disclosure relates to triggering beamsteering of a radio communication antenna mounted to a mounting structure.

### BACKGROUND

A high-gain antenna may be described as an antenna with a focused and narrow radio beam. With the focused and narrow radio beam, the high-gain antenna is enabled to precisely target its radio signals. The high-gain antenna may be a directional antenna. Due to the narrow beams of high-gain antennas used at E-band, the link performance is highly affected by misalignment and mounting structure movement. Therefore, very rigid mounting structures are typically required in order to minimize the movement of the mounting structure. For example, a 60 cm E-band reflector has half-power beam width of approximately 0.5 degree. This causes limitations on where it is possible to deploy such links. The E-band covers the frequency range of 60-90 GHz, and signals in the E-band have wavelengths in the range of 3.33-5 mm and the E-band is used for microwave backhaul links.

Antennas may be displaced, i.e. tilted, or misaligned. One reason for the displacement or misalignment may be movement of the antenna caused by movement of the mounting structure that the antenna is mounted on. Movement of the antenna may be caused by external forces such as wind, vibrations in the ground, thermal forces etc. High-gain antennas that are arranged to compensate for movements causing antenna displacement or misalignment often employ mechanical beamsteering and use sensors to detect the movement and actuators to mechanically adjust the geometry of the antenna, e.g. by moving the feed or subreflector, to achieve beamsteering.

A motion sensor, such as an Inertial Measurement Unit (IMU), may be used to sense and measure the movement causing displacement or misalignment of the antenna and compensate the beamsteering based on the motion sensor output. This may be done in combination with other sensors or information, such as the Received Signal Strength Indication (RSSI) or Received Signal Level (RSL). Due to the small movement that the sensors have to detect, they have to be very sensitive. This means that their output not only comprises the movement of the antenna, but also noise and other unwanted distortions that are picked up by the sensor, in addition to the inherited measurement uncertainty of a sensor. To remove these unwanted contributions, the signal can be filtered. However, the filtering introduces delay and signal distortion in most cases, which can affect the steering performance.

There may be two main causes of movement causing antenna alignment; 1) thermal-induced bending of the mounting structure due to solar heating, and 2) wind movement, which is quite fast in comparison to thermal bending. Thermal bending can be compensated well using cost-effective motion sensors, such as accelerometers and RSSI. Due to the slow nature of this movement, maximally a few tenths of a degree per hour, the compensation does not require expensive and highly responsive hardware. Extensive filtering can be applied to the signal from the sensor, since the delay caused by this filter is not a problem, and the requirements on the delay in motor actuation and speed of the actuator are very relaxed.

Fast movement, e.g. movement above a threshold, such as that induced by wind, is much more of a challenge for the control circuit. This movement may be in the order of 1-5 Hz and requires a very low delay between estimation of the beam direction and actuation of the motor to achieve the desired position of the antenna feed. If the beamsteering is too slow compared to the tilt caused by fast movement, the antenna tilts faster than the antenna can adapt its beam to, causing misalignment and large drop in received signal. This means that extensive filtering cannot be applied to remove noise because that introduces delay, and thit also means that a fast control loop with minimal delay time between estimation of the new beam position and the actuation of the motor is needed.

The frequency of the movement depends on the physical properties of the mounting structure; in many cases, the antennas are mounted in a tall self-supporting mounting structure which has a tendency to move around at a certain frequency, e.g. behaving similarly to a huge tuning fork. The amplitude of the movement can vary quite a lot and depends on the excitation, e.g. strong or soft wind. However, the amplitude variation is slow compared to the period of the movement.

Fast movement compensation requires accurate and fast sensor readings and fast processing. The control is very sensitive to measurement impairments due to for example noise, vibrations, and drift. While filtering is possible in some cases, it is rather difficult to combine the speed and accuracy requirements that compensation of wind movement and similar poses to the antenna system. Fast sampling and processing of the sensor data is required which may require more expensive circuitry.

The delay has to be small in order to be able to capture faster wind events, but, due to the accuracy requirements, any measurement impairments need to be compensated for. Thus, such an antenna system may require significant real-time processing capability.

Combining these performance requirements requires expensive hardware.

Therefore, there is a need to at least mitigate or solve this issue.

### SUMMARY

An objective is to obviate at least one of the above disadvantages and to provide improved handling of a radio communication antenna.

According to a first aspect, the objective is achieved by a computer-implemented method performed by a control unit for triggering beamsteering of a radio communication antenna mounted to a mounting structure. The control unit obtains a motion signal indicating movement of the mounting structure. The control unit generates a compensation signal based on the motion signal. The compensation signal is in-phase with the motion signal. The control unit triggers beamsteering of the radio communication antenna using the motion compensation signal, thereby compensating the movement of the mounting structure.

According to a second aspect, the objective is achieved by a control unit for triggering beamsteering of a radio communication antenna mounted to a mounting structure. The control unit is configured to perform the method of the first aspect.

According to a third aspect, the objective is achieved by a radio communication antenna comprising the control unit of the second aspect.

According to a fourth aspect, the objective is achieved by a computer program product comprising program code for performing, when executed by the processing circuitry, the method of the first aspect.

According to a fifth aspect, the objective is achieved by a non-transitory computer-readable storage medium comprising instructions, which when executed by the processing circuitry, cause the processing circuitry to perform the method of the first aspect.

Since the compensation signal is in-phase with the motion signal, i.e. it has a fixed phase relation with the movement, i.e. the angular change, of the antenna causing misalignment, the movement of the antenna is at least partly compensated by changing the angle of the antenna beam so that the handling of the antenna is improved.

The present disclosure herein affords many advantages, of which a non-exhaustive list of examples follows:

An advantage of the present disclosure is that the complexity and cost for the hardware in the movement compensating antenna system is low. For example, a less expensive motion sensor is required, or no sensor in the case of operation on only RSSI. The delay caused by processing the sensor data does not affect or is less problematic for the beamsteering.

Another advantage of the present disclosure is that the compensation can be tailored for the timescales of the event, e.g. slow movement filtered and removed separately from fast movement. The detection of frequency and amplitude is split allowing it to be possible to exploit the fact that the movement envelope changes much more slowly than the actual movement of the antenna.

A further advantage of the present disclosure is that it provides a simple control scheme, less computational complexity and lower sampling-rate requirements.

Yet another advantage of the present disclosure is that it is less sensitive to the antenna system's bandwidth or delays. For example, if there is delay in steering the antenna beam that can be compensated for, as long as there is a fixed phase difference between input and output.

The present disclosure is not limited to the features and advantages mentioned above. A person skilled in the art will recognize additional features and advantages upon reading the following detailed description.

### BRIEF DESCRIPTION OF THE DRAWINGS

The present disclosure will now be described in more detail by way of example only in the following detailed description by reference to the appended drawings in which:

FIG. 1 is a schematic drawing illustrating an antenna system.

FIG. 2 is a block diagram illustrating generation of the compensation signal.

FIG. 3 is a flow chart illustrating a method.

FIG. 4 is a block diagram illustrating generation of the compensation signal.

FIG. 5 is a block diagram illustrating generation of the compensation signal.

FIG. 6 is a flow chart illustrating a method.

FIG. 7 is a block diagram illustrating generation of the compensation signal.

FIG. 8 is a block diagram illustrating generation of the compensation signal.

FIG. 9 is a flow chart illustrating a method.

FIG. 10 is a block diagram control unit.

The drawings are not necessarily to scale, and the dimensions of certain features may have been exaggerated for the sake of clarity. Emphasis is instead placed upon illustrating the principle.

### DETAILED DESCRIPTION

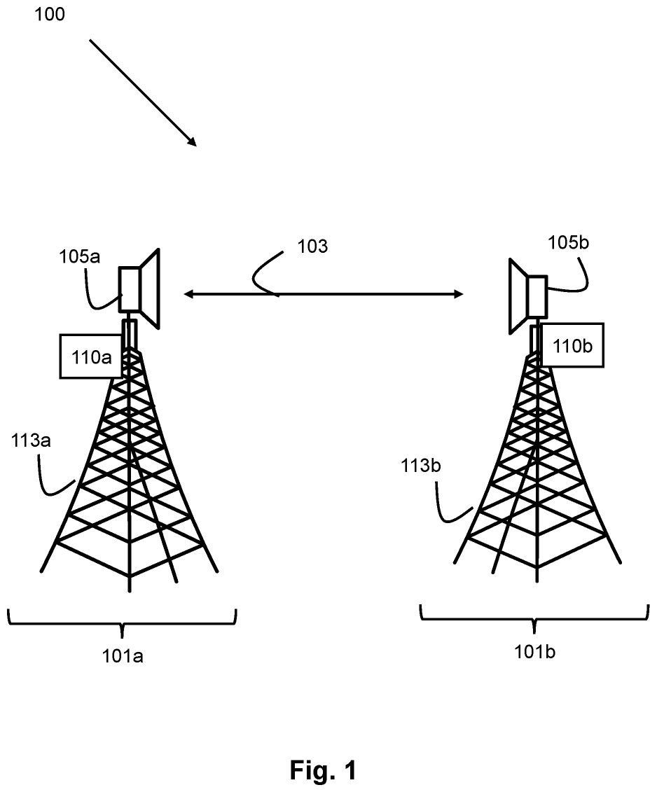

FIG. 1 is a schematic drawing illustrating an antenna system 100. For the sake of simplicity, the term system together with the reference number 100 may be used herein when referring to the antenna system 100. The system 100 may be referred to as a point-to-point radio link arrangement, a communication network etc.

The system 100 comprises at least two nodes, e.g. a first node 101a and a second node 101b. The first node 101a and the second node 101b are arranged to communicate with each other over a point-to-point wireless link 103. The reference number 101 may be used herein wherein referring to any of the first node 101a and the second node 101b. A node 101 may be referred to as a system node, a link node etc. For the sake of simplicity, the term link together with the reference number 103 may be used herein when referring to the point-to-point wireless link 103.

The first node 101a comprises or is arranged to connect to a first radio communication antenna 105a and the second node 101b comprises or is arranged to connect to a second radio communication antenna 105b. For the sake of simplicity, the term antenna may be used herein when referring to a radio communication antenna and the reference number 105 may be used herein when referring to any of the first antenna 105a and the second antenna 105b.

The antenna 105 may be a high gain antenna, beamsteering antenna, radio link antenna, a high gain reflector antenna for wireless backhaul etc. The antenna 105 may be a steerable antenna, i.e. it may be arranged to steer its beam to a certain direction. For example, the antenna 105 may steer the beam in a horizontal direction, a vertical direction or both, and the direction are with respect to ground. When the antenna 105 is steerable it is arranged to adjust its beam to cope with or compensate for misalignment. The range of steering may be for example a few degrees.

The first antenna 105a and the second antenna 105a are each arranged to transmit and receive data in signals over the link 103.

The first antenna 105a is arranged to be connected to a first radio communication device 110a, and the second antenna 105b is arranged to be connected to a second radio communication device 110b. For the sake of simplicity, the term radio may be used herein when referring to a radio communication device and the reference number 110 may be used herein when referring to any of the first radio 110a and the second radio 110b.

The radio 110 is arranged to generate a Radio Frequency (RF) signal, and provide it to the antenna 105. The antenna 105 is arranged to transmit the RF signal that is generated by the radio 110. The first antenna 105a may be arranged to receive another RF signal from the second antenna 105b that has been generated by the second radio 110b of the second antenna 105b, or vice versa, or it may be arranged to receiver another RF signal from any other suitable entity.

The first antenna 105a is arranged to be mounted on a first mounting structure 113a and the second antenna 105b is arranged to be mounted on a second mounting structure 113b. Each of the first mounting structure 113a and the second mounting structure 113b may be for example a mast, a tower, a pole etc. The reference number 113 may be used herein when referring to any of the first mounting structure 113a and the second mounting structure 113b. The radio 110 may be arranged to be mounted to the mounting structure, or the radio 110 may be arranged to be remotely located from the mounting structure 113, i.e. it is located a distance from the mounting structure 113 and is arranged to communicate with the antenna 105.

The mounting structure 113 may be subject to external forces that may cause the mounting structure 113 to move. The external forces may be for example weather events such as wind, precipitation, heat and cold, it may be vibrations introduced by traffic in the surroundings of the system 100 etc. The antenna 105 moves as a result of the movement of the mounting structure 113, and the movement may cause the orientation of the antenna 10 to change, i.e. the antenna becomes misaligned. Misalignment of the antenna 105 may cause the beam of the antenna 105 to point into another direction, i.e. its direction changes, and this may degrade the received RF signal on both sides of the link 103. The movement of the antenna 105 is an angular change of the antenna 105. The movement may be referred to as sway.

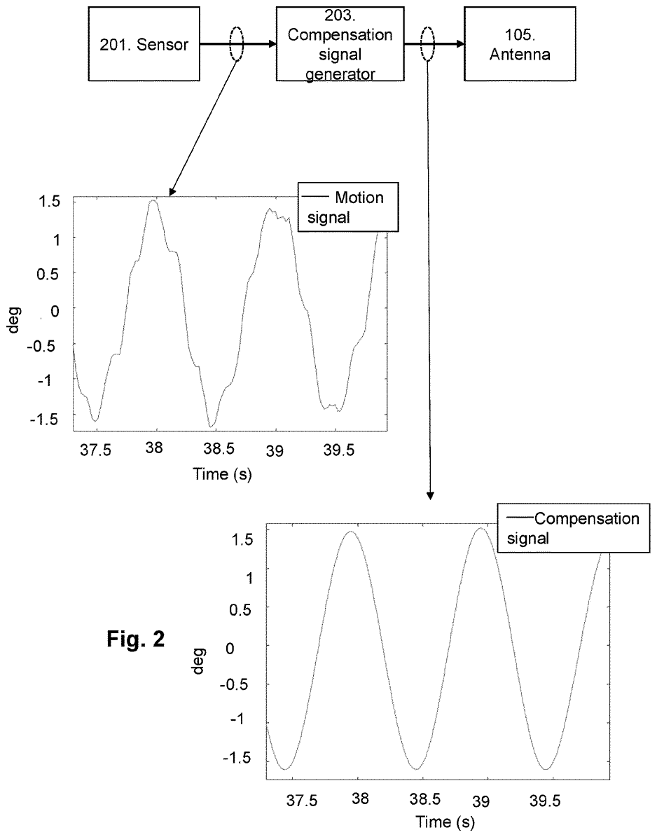

The present disclosure utilizes a compensation signal to compensate for the movement of the antenna 105, i.e. angular changes of the antenna 105. The present disclosure provides a compensation algorithm or strategy for compensating the movement of the antenna 105 on the link 103 that synchronizes to the movement frequency of the mounting structure 113 and steers the beam from the antenna 105 in-phase with the movement that causes misalignment of the antenna 105. This is different from steering the beam based on an instantaneous motion sensor signal. Since the compensation signal for steering the antenna beam is phase aligned to the output signal from a sensor 201 (the sensor 201 is illustrated in FIG. 2 and will be described in more detail later), such as motion signal, signal strength level, signal quality, BLER, RSSI value etc., the delay may become quite large, which relaxes requirements on hardware and signal processing which may provide advantages such as e.g. it may be possible to do more signal processing, to have slower processing, employ sharper filters with longer group delay, etc. The compensation signal may be associated with a misalignment of the antenna 105.

The movement of the mounting structure 113 has distinct frequency components and amplitude with limited change from period to period. In other words, the movement of the mounting structure 113 is not a random movement. Based on the frequency components of the movement that cause the misalignment, a compensation signal that is a close approximation of the instantaneous misalignment-inducing movement may be generated. Because the compensation signal has the same frequency, is in-phase, and has very similar amplitude as the misalignment-inducing movement, the compensation signal may be used instead of the instantaneous movement.

From the motion signal from the sensor 201, 4a compensation signal is generated that has the same (relevant) frequency components, has similar amplitude, and is in-phase with the movement of the mounting structure 113. This compensation signal, which is a delayed and filtered copy, of the motion signal, is used by the antenna 105 to compensate for the movement of the mounting structure 113. The algorithm may be further improved by estimating the dominant movement components that degrade the link performance from the received signal level of the link 103, e.g. RSSI or RSL.

There may be at least two approaches to generate the compensation signal: 1) a filter-and-delay approach, and 2) a phase locked loop (PLL) and envelope detector approach. Before describing the two approaches, the concept for the in-phase compensation strategy will be described in general.

FIG. 2 is a block diagram illustrating generation of the compensation signal. FIG. 2 illustrates a sensor 201. The sensor 201 is comprised in the system 100. The sensor 201 may be mounted on the mounting structure 113 or it may be comprised in or connected to the antenna 105 or the radio 110. The sensor 201 is arranged to sense and measures movement of the mounting structure 113 that causes change in rotation of the antenna 105, i.e. misalignment of the antenna 105. The sensor 201 is arranged to provide a sensor signal which represents the movement of the antenna 105, i.e. the rotation of the antenna 105. The sensor signal may be a motion sensor signal, a motion signal, an output signal, sensor data, motion data, etc., and the term motion signal may be used herein when referring to any of these. The motion signal may be referred to as a raw motion signal. The motion signal may be raw in that it is the signal that comes out of the sensor 201, i.e. the signal that is produced by the sensor 201. The motion signal may represent movement of the antenna 105 in one particular time instance, or it may represent movement of the antenna 105 during a time period. The sensor signal which represents the movement of the antenna 105 may be an angular change, i.e. rotation, of the antenna, or the sensor signal represents all movement of the antenna 105 and the sensor 201 may be arranged to extract the rotation signal from the sensor signal. The sensor 201 may be a motion sensor, a motion detector etc. The sensor 201 may be or may be comprised in an IMU, a RSSI meter, the radio 110 etc. The radio 110 may be arranged to act as the sensor 201 or it may comprise the sensor 201. The upper left located graph in FIG. 2 illustrates an example of the motion signal generated by the sensor 201. The x-axis of the graph represents time measured in seconds and the y-axis represents degree. The motion signal comprises a dominant main frequency component, and other frequency components have less power. The motion signal from the sensor 201 comprises disturbances. Even though FIG. 2 illustrates one sensor 201, there may be any n number of sensor 201, where n is a positive integer.

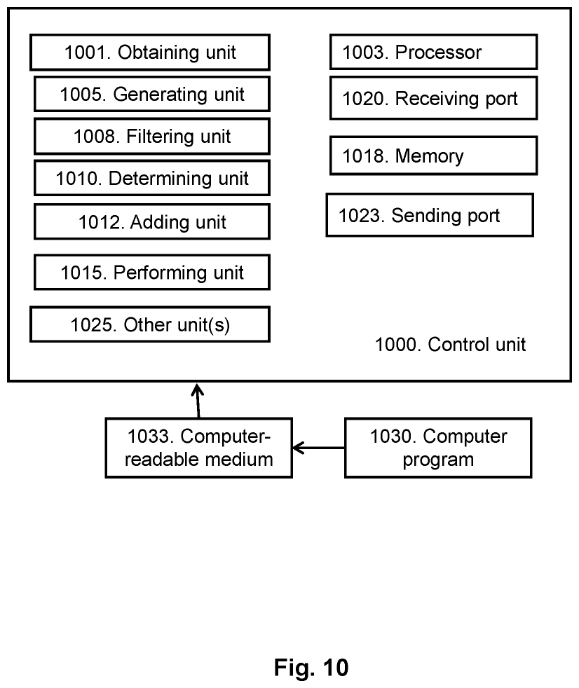

The sensor 201 provides the motion signal to the compensation signal generator 203. The compensation signal generator 203 may be a control unit 1000 or comprised in the control unit 1000. The reference number 1000 is found in FIG. 10, which will be described in detail later. The compensation signal generator 203 may be comprised in the system 100. The compensation signal generator 203 generates the compensation signal based on the motion signal. The lower right graph in FIG. 2 illustrates an example of the compensation signal. The x-axis of the graph represents time measured in seconds and the y-axis represents degree. The compensation signal comprises the same dominant frequency components as the motion signal generated by the sensor 201. In the compensation signal, the at least some of the unwanted disturbances from the motion signal are removed. The compensation signal has a comparable amplitude as the motion signal from the sensor 201. The compensation signal is in-phase with the motion signal from the sensor 201, i.e. the compensation signal is in-phase with the movement of the mounting structure 113 and substantially all unwanted components of the motion signal are removed.

The compensation signal generator 203 provides the compensation signal to the antenna 105 which steers its beam accordingly. Using other words, the compensation signal is applied to the antenna 105. The compensation signal may have a large delay from the motion signal from the sensor 201.

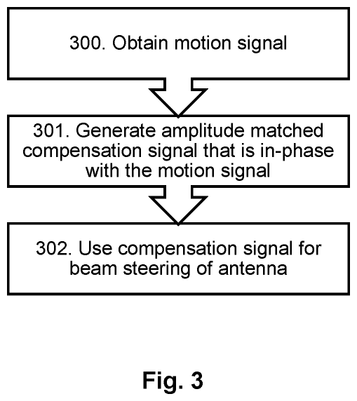

FIG. 3 is a flow chart illustrating a method. The method is performed by a control unit 1000. The control unit 1000 may be the compensation signal generator 203. The method describes a procedure for generating a compensation signal for compensating movement of the antenna 105 that is in-phase with the movement but can have a delay to the movement. As mentioned earlier, the movement that is compensated for is the one that causes change in rotation of the antenna 105, i.e. misalignment of the antenna 105. The method comprises at least one of the following steps, which steps may be performed in any suitable order than described below:

### Step 300

A motion signal is obtained from the sensor 201. The step may be described as taking raw sensor data from the sensor 201. The motion signal may represent a rotational movement of the antenna 105, i.e. an angular change of the antenna 105.

### Step 301

A compensation signal is generated. The compensation signal may be described as an amplitude matched compensation signal. The compensation signal is in-phase with the movement of the antenna 105, i.e. the rotation. Since the compensation signal is used for beamsteering, i.e. to change the rotation of the beam to a certain degree, the compensation signal is consequently also in degrees.

### Step 302

The compensation signal is used for beamsteering of the antenna 105.

The first of the two approaches for generating the compensation signal will now be described in more detail.

### 1) Filter-and-Delay Approach

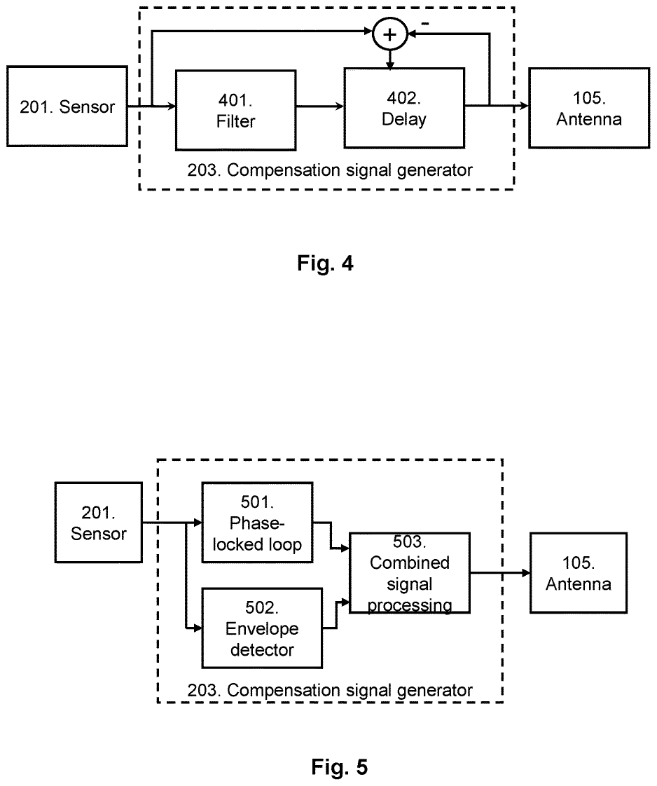

FIG. 4 is a block diagram illustrating the first approach for generating the compensation signal. The sensor 201 obtains a motion signal which indicates the movement of the antenna 105. The motion signal may represent only a rotational movement of the antenna 105, or it may comprise all movement of the antenna 105 such that the sensor 201 then may extract the rotational movement signal from the motion signal. The sensor 201 may be any sensor which is arranged to sense and measure movement, such as a motion sensor or the received signal level from the radio 110, e.g. RSSI or RSL. The motion signal is provided to the compensation signal generator 203, e.g. a control unit 1000, which generates the compensation signal. As exemplified in FIG. 4, the generation of the compensation signal may be performed in two steps: Filter 401 is arranged to filter the motion signal. A delay unit 402 is arranged to add a delay to the filtered motion signal. The motion signal from the sensor 201 may be described as an input signal to the compensation signal generator 203 and the compensation signal may be described as an output signal from the compensation signal generator 203. The compensation signal that is used to steer the antenna beam is a filtered and delayed version of the motion signal. The filter 401 is arranged to remove unwanted components and disturbances from the motion signal from the sensor 201. This introduces a delay which would make the beamsteering lag the actual movement, which is a problem when trying to compensate for movement that is fast. This is solved by adding an additional delay to bring the compensation signal, i.e. the output signal, in phase with the motion signal, i.e. the input signal, by minimizing the difference between them. As seen in FIG. 4, the delay may be determined by subtracting the motion signal from the compensation signal. Doing so, beamsteering is done in-phase with the movement and the disturbances of in the motion signal are removed.

FIG. 5 is a block diagram illustrating the second approach for generating the compensation signal. As in the first approach, the sensor 201 obtains a motion signal which represents the movement of the antenna 105, i.e. rotational movement of the antenna 105. The sensor 201 may be any sensor which is arranged to sense and measure movement, such as a motion sensor or the received signal level from the radio 110, e.g. RSSI or RSL. The motion signal is provided to the compensation signal generator 203, e.g. a control unit 1000, which generates the compensation signal. As exemplified in FIG. 5, the generation of the compensation signal may be performed in three steps: A PLL 501 is arranged to perform a phase-locked loop procedure using the motion signal. An envelope detector 502 is arranged to perform an envelope detector procedure using the motion signal. The PLL 501 and the envelope detector 502 may perform their respective procedures in parallel, i.e. at the same time, or they one after the other or in any suitable order. The output from the PLL 501 and the output from the envelope detector 502 are combined in the combined signal processing unit 503. The output from the combined signal processing unit 503 is the compensation signal which is provided to the antenna 105. Thus, the second approach which is exemplified in FIG. 5, uses a phase-locked loop to do the frequency synthesis and an envelope detector to determine the appropriate amplitude. The combined signal processing unit 503 generates the compensation signal to be fed to the antenna 105. The compensation signal is smooth and in perfect phase with the motion signal, but the sharp edges and unwanted components are removed, making steering the antenna beam smooth. The filtered signal has a delay compared to the motion signal and is much more distorted.

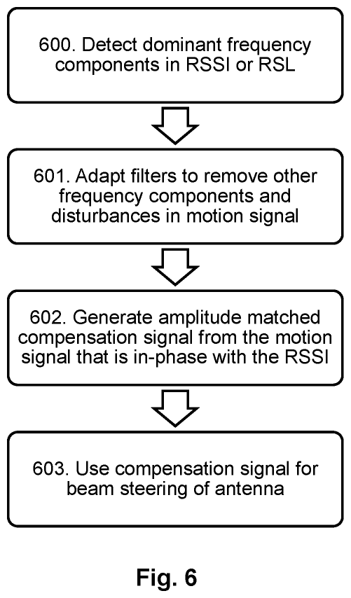

The compensation signal may be generated taking a RF signal into account. The radio 110 determines the RF signal, and the radio 110 may determine at least one performance parameter based on the RF signal, The at least one performance parameter may be e.g. RSSI, RSL etc. The at least one performance parameter may be a representation of the RF signal. The control unit 1000 may provide a request for the performance parameter to the radio 110 and the radio 110 may provide the requested performance parameter to the control unit 1000, or the radio 110 may provide the performance parameter to the control unit 1000 at predetermined time instances, at a predetermined time interval, it may be provided continuously, or at any suitable time. By using the RF signal or a representation of the RF signal from the radio 110 in the generation of the compensation signal, the filter components may be adapted to only keep the relevant components from the movement, i.e. those that affect the performance parameter. The delay in the actual beamsteering may also be compensated so that the beamsteering is in-phase with the movement. In the approach exemplified in FIG. 3, the compensation signal applied to the antenna 105 is in-phase with the movement, but delay in the beamsteering may introduce a lag. FIG. 6 is a flow chart illustrating a method illustrating generation of the compensation signal based on the RF signal. Before step 600, the radio 110 has determined the RF signal and it has also determined at least one performance parameter based on the RF signal, and the at least one performance parameter has been provided to the control unit 1000.

The method comprises at least one of the following steps, which steps may be performed in any suitable order than described below:

### Step 600

The control unit 1000 detects the dominant frequency components in the at least one performance parameter from the radio 110, e.g. the RSSI, RSL, signal quality, error rate etc.

### Step 601

The control unit 1000 adapts the filter 401 such that they remove other frequency components and disturbances in the motion signal. The filtering is performed and afterwards, only the relevant components from the movement remain, i.e. those that affect the performance parameter.

Step 602

This step corresponds to step 301 in FIG. 3. The control unit 1000 generates the compensation signal which is an amplitude matched compensation signal from the motion signal that is in-phase with the performance parameter.

### Step 603

This step corresponds to step 302 in FIG. 3. The control unit 1000 uses the compensation signal for beamsteering of the antenna 105, e.g. the control unit 1000 provides the compensation signal to the antenna 105 and the antenna 105 steers its beam accordingly.

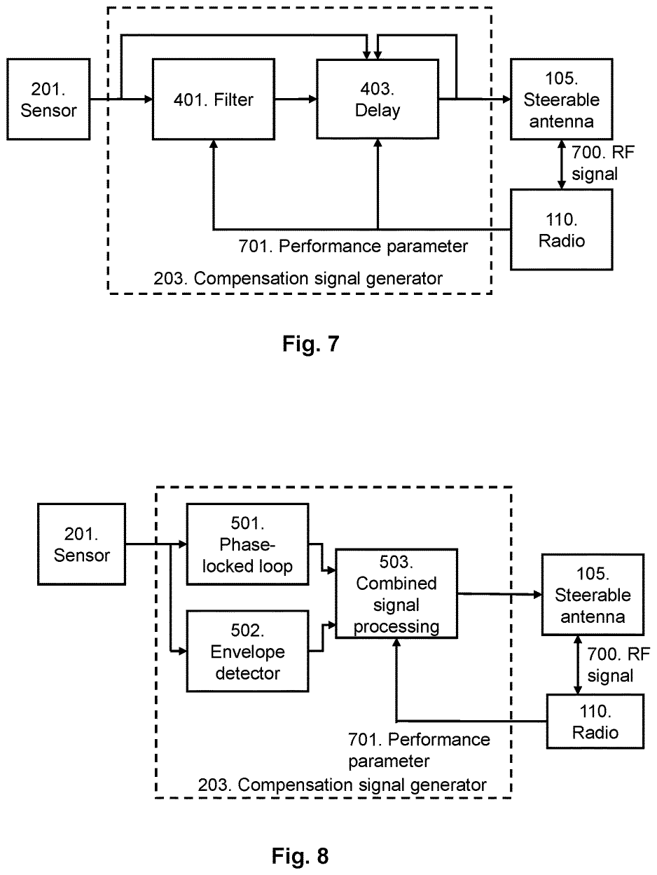

FIG. 7 is a is a block diagram illustrating how the RF signal may be comprised in the first approach of generating the compensation signal, i.e. the method in FIG. 6 applied to the first approach. As illustrated in FIG. 7, the radio 110 determines an RF signal 700 and at least one performance parameter 701 based on the RF signal 700. The radio 110 provides the at least one performance parameter 701 to the compensation signal generator 203. At least one or both of the filter 401 and the delay unit 403 comprised in the compensation signal generator 203 uses the at least one performance parameter 701 and together determines the compensation signal. The delay unit 403 may now compensate for the finite beamsteering speed of the antenna 105. The filter 401 may be adapted to only keep the components of the motion signal that affect the performance parameter, e.g. the RSSI or RSL.

FIG. 8 is a is a block diagram illustrating how the RF signal may be comprised in the second approach of generating the compensation signal, i.e. the method in FIG. 6 applied to the second approach. As illustrated in FIG. 7, the radio 110 determines an RF signal 700 and at least one performance parameter 701 based on the RF signal. The radio 110 provides the at least one performance parameter 701 to the compensation signal generator 203. The combined signal processing unit 503 in FIG. 8 may use the at least one performance parameter 701 to determine the compensation signal. Similar to FIG. 7, the received performance parameter from the radio 110 may be used in the generation of the compensation signal, i.e. to improve the movement compensation.

The present disclosure utilizes the insight that the movement of the antenna 105 is dominated by the natural resonance frequencies of the antenna 105. Due to the large mass of the mounting structure 113 to which the antenna 105 is connected, the envelope, i.e. the smooth curve outlining the amplitude extrema, of the movement changes slowly. In other words, the amplitude difference from one movement period to the next is small and can be assumed to be smaller than the beam width of the antenna. Therefore, it is possible to have near-perfect compensation of mounting structure movement by applying a compensation signal to the beamsteering of the antenna 105 that:
1. has the same frequency as the dominant oscillations of the movement,
2. has a fixed phase relationship to the movement, e.g. 0 deg, 360 deg, 720 deg, etc.,
3. has an amplitude which is approximately equal to the amplitude of the last movement period(s).

From an unfiltered motion signal from the sensor 201, a compensation signal is generated that is used by the antenna 105 to do the beamsteering. The generated compensation signal is a filtered version of the motion signal, e.g. a raw sensor signal, from the sensor 201: disturbances are removed, only the relevant frequency components remain, it has similar amplitude, and it is in-phase with the motion signal, but it lags behind the motion signal.

As mentioned earlier, there may be at least two approaches to obtain such an in-phase and amplitude-matched compensation signal. The first approach is based on a delayed version of the motion signal from the sensor 201. The second approach is achieved by generating a new signal that is phase-locked to the motion signal.

### 1. First Approach: Filtered-and-Delayed Approach

Use a sensor 201 such as an IMU or RSSI meter to detect the movement of the antenna 105. In the generation of the compensation signal, a delay may be added to the motion signal and the amplitude may be adapted so that it is in phase with the movement of the antenna 105. If needed, filtering may be done on the motion signal before adding the correct delay to remove noise and other impairments. This is shown in FIG. 4.

### 2. Second Approach: Phase-Locked Loop & Envelope Detection Approach

As visualized in FIG. 5, the compensation signal may be generated by using a PLL 501 and an envelope detector 502. The frequency synthesis may be done by the PLL 501, while the amplitude of the signal may be generated by the envelope detector 502. If the antenna 105 resonates at multiple frequencies, a cascaded approach may be used where the dominant frequency of the motion signal from the motion sensor is first detected and cancelled, and then the second frequency is detected and cancelled, and so on until the wanted performance is achieved. The dominant frequency relates to the displacement that causes misalignment and it may be a superposition of multiple frequencies. If the performance parameter, e.g. RSSI or similar, is used as input signal to the compensation signal generator 203, then the amplitude of the generated compensation signal may be adjusted to not completely remove the movement so that a residual movement value is kept to which the PLL 501 can lock. If this residual movement is small enough it will not impact the performance of the link 103.

The phase, and implicitly the frequency, of the movement may be estimated separately from the envelope, which has the benefit that the processing can be tailored for the timescales of the individual processes. Using this approach, the system does not need to track the actual movement of the antenna 105, which can be quite rapid, but only the change in movement, i.e. the envelope, which is a much slower process. Hence, more advanced filtering may be possible which in turn allow for the use of cheaper hardware comprised in the control unit 1000. Note that the sinusoidal shape of the movement, a direct approach may need to track the high-derivative signal flanks. More advanced filtering may comprise more operations on the signal and as such it introduces a larger delay. The advanced filtering may be more low pass filtering.

### Using the Performance Parameter to Improve the Performance

The motion signal may comprise disturbances which are not caused by tilting of the antenna 105. For example lateral movements of the antenna 105, or vibrations. When the movement has multiple frequency components, not all of these components have amplitudes that are large enough to disturb the link's performance, e.g. due to the width of the beam of the antenna 105. The performance parameter, e.g. RSSI, RSL or similar, may be used to determine which are the dominant oscillating frequencies of the mounting structure 113. This information may be used to adapt the filter 401 and remove the unwanted frequency components and disturbances from the motion signal from the sensor 201.

In the antenna 105 there will be a certain delay between the compensation signal, i.e. input, and the steering of the beam to the necessary direction, i.e. the output. This response time may depend on the actuators and the mass of the antenna 105 that needs to be moved in case of mechanical steering. By using the performance parameter, e.g. RSSI or similar, in the control loop, the actual beamsteering may be brought in-phase with the movement and substantially all negative influences of delay in the different components are removed. Methods and block diagrams related to using the performance parameter are shown in FIG. 6, FIG. 7 and FIG. 8

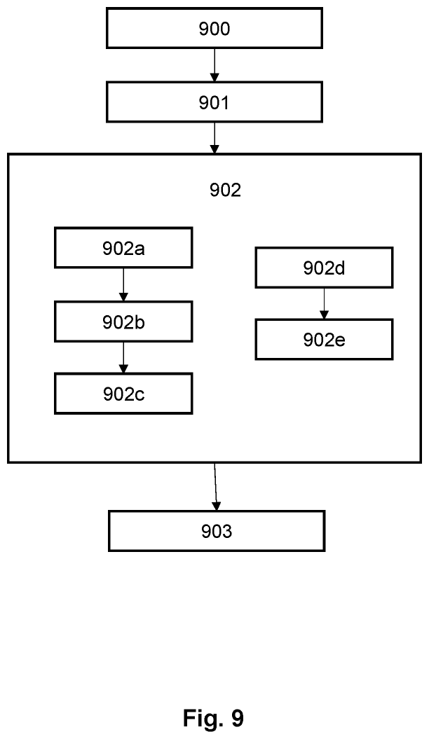

The method performed by the control unit 1000 for triggering beamsteering of an antenna 105 mounted to a mounting structure 113 will now be described with reference to the flowchart depicted in FIG. 9. The method in FIG. 9 may be performed one or multiple times. The method comprises the following steps, which steps may as well be carried out in another suitable order than described below.

### Step 900

This step corresponds to step 300 in FIG. 3. The control unit 1000 obtains a motion signal indicating movement of the antenna 105. The movement of the antenna 105 may be a rotational movement, i.e. an angular change.

The motion signal may be obtained from a motion sensor 201. The motion signal may be obtained from at least one of an IMU and/or a radio 110 associated with the antenna 105.

The motion sensor 201 may be an IMU and/or a radio 110 associated with the antenna 105.

The motion signal may comprise a time series of motion signals from a plurality of motion sensing instances.

### Step 901

This step corresponds to step 701 in FIG. 7. The control unit 1000 may obtain a performance parameter from a radio 110 associated with the antenna 105.

The performance parameter may be a received power parameter, e.g. RSSI, RSL, Mean Square Error (MSE), signal quality, error rate etc.

### Step 902

This step corresponds to step 301 in FIG. 3 and step 602 in FIG. 6. The control unit 1000 generates a compensation signal based on the motion signal. The compensation signal is in-phase with the motion signal.

The compensation signal may be generated further based on the performance parameter from step 901.

The compensation signal may have at least one of:
a same frequency as a second type of frequency component of the motion signal; and/or
a fixed phase relationship to the motion signal; and/or
an amplitude which is at least substantially matches an amplitude of the motion signal.

### Step 902a

This step corresponds to step 401 in FIG. 4. This step may be a substep of step 902. The control unit 1000 may filter the motion signal by removing a first type of frequency component and/or disturbances from the motion signal such that a second type of frequency component is maintained in the motion signal.

The first type of frequency component may be other frequency components, i.e. other than the dominant frequency component. The second type of frequency component may be the dominant frequency component.

### Step 902b

This step corresponds to step 402 in FIG. 4. This step may be a substep of step 902. The control unit 1000 may determine a time delay based on the motion signal.

Note that the first time step 902b is performed, i.e. when the method is initialized, there may be a predefined time delay. The predefined time delay may be 0 or it may have any other value. The predefined time delay may match an assumed delay in the system 100, for example it may be calibrated or determined based on filter design, antenna motor settings etc. The second and consecutive times step 902b is performed, then the time delay may be determined both on the motion signal and the compensation signal, as exemplified by the feedback loop in FIG. 4 and FIG. 7.

### Step 902c

This step corresponds to step 402 in FIG. 4. This step may be a substep of step 902. The control unit 1000 may add the time delay to the filtered motion signal. The compensation signal comprises the filtered motion signal with the added time delay.

Steps 902a, 902b and 902c may be performed instead of steps 902d and 902e. Thus, steps 902a, 902b and 902c may be an alternative to steps 902d and 902e. Steps 902a, 902b and 902c may be comprised in the first approach and steps 902d and 902e may be comprised in the second approach mentioned earlier.

### Step 902d

This step corresponds to step 501 in FIG. 4. This step may be a substep of step 902. The control unit 1000 may perform a PLL procedure based on the motion signal to generate a phase-locked motion signal.

The input to the PLL procedure is the motion signal.

The PLL procedure comprises to determine the phase and frequency of a reference signal, i.e. the motion signal from the sensor 201, and using this to generate a clean signal that is anti-phase with the movement of the antenna 105. The PLL procedure does this by detecting the phase difference between a signal generated by a controllable oscillator, here it is likely a purely digital system, but it could be analog as well, with the input signal. The input signal may be the motion signal, and the motion signal may be generated by the motion sensor, it may be detected by the radio 110 or both. An error signal that is proportional to the phase error is output, and the signal is filtered with a loop filter to have a clean control signal that then is used to set the frequency of an oscillator.

A goal for the PLL procedure may be to phase-align the generated signal with the input signal, the generated signal can then be used to control the fast part of the movement compensation.

The PLL procedure may comprise one or more of the following steps:
i. A phase detection step: Obtain a phase difference between input signal and signal generated by the PLL.
ii. A (loop) filter step: Remove noise from the detected phase from step i. Using other words, filter the phase difference with a simple Low Pass filter to remove noise.
iii. A signal generation step: Generate a signal based on the signal from the previous steps i and ii. In other words, generate a sinusoidal signal that follows the input signal, i.e. same phase, same frequency. This signal is used by the phase detector at step i.
iv. A feedback from the generated signal to the phase detection step: To get same phase on the input signal and the output signal, i.e. the generated signal. In other words, to create a copy of the signal of step iii but with 90 degrees offset. This is the actual output of the PLL.

### Step 902e

This step corresponds to step 502 in FIG. 4. This step may be a substep of step 902. The control unit 1000 may perform an envelope detection procedure based on the motion signal to generate an envelope motion signal. The compensation signal may be a combination 503 of the phase-locked motion signal and the envelope motion signal.

The input to the envelope detection procedure may be the motion signal from the sensor 201.

The PLL procedure in step 901d has generated a clean phase-locked sinewave of a set amplitude. This corresponds to the fast movement of the resonant antenna 105. However, the overall envelope of the signal varies although much more slowly. Therefore, an envelope detection procedure may be necessary. Any suitable envelope detection procedure may be performed. One example of an envelope detection procedure may comprise to rectify the input signal and passing it through a low pass filter. The envelope detection procedure comprises to detect the variation in sine-wave amplitude while not being affected by the underlying sine itself.

### Step 902

This step corresponds to step 302 in FIG. 3 and step 603 in FIG. 6. The control unit 1000 triggers beamsteering of the antenna 105 using the compensation signal, thereby compensating the movement of the antenna 105, i.e. its rotational movement. Triggering the beamsteering may comprise to send a beamsteering instruction to the beamsteering unit of the antenna 105. The beamsteering unit of the antenna 105 may convert the movement that causes displacement into a corresponding change of beam direction, so that this physical misalignment is undone. For example, in the case of mechanical beamsteering, it may be the motor that moves the feeder of the antenna 105. In case of electrical beamsteering, the antenna 105 may comprise a beamforming circuit that may adapt the beam accordingly.

To perform the method steps shown in FIG. 9 for triggering beamsteering of the antenna 105 mounted to a mounting structure 113, the control unit 1000 may comprise an arrangement as shown in FIG. 10. The control unit 1000 is arranged to perform the method of FIG. 9. As mentioned earlier, the control unit 1000 may comprise the compensation signal generator 203 or it may be the compensation signal generator 203.

The control unit 1000 is arranged to, e.g. by means of an obtaining unit 1001, obtain a motion signal indicating movement of the antenna 105, i.e. its rotational movement. The obtaining unit 1001 may also be referred to as an obtaining unit, an obtaining means, an obtaining circuit, means for obtaining etc. The obtaining unit 1001 may be a processor 1003 of the control unit 1000 or comprised in the processor 1003 of the control unit 1000.

The motion signal may be obtained from a motion sensor 201. The motion signal may be obtained from at least one of an IMU and/or a radio 110 associated with the antenna 105.

The motion sensor 201 may be an IMU and/or a radio 110 associated with the antenna 105.

The motion signal may comprise a time series of motion signals from a plurality of motion sensing instances.

The control unit 1000 may be arranged to, e.g. by means of the obtaining unit 1001, obtain a performance parameter from a radio 110 associated with the antenna 105.

The performance parameter may be a received power parameter, e.g. RSSI, RSL, Mean Square Error (MSE) etc.

The control unit 1000 is arranged to, e.g. by means of a generating unit 1005, generate a compensation signal based on the motion signal. The compensation signal is in-phase with the motion signal. The generating unit 1005 may also be referred to as a generating unit, a generating means, a generating circuit, means for generating etc. The generating unit 1005 may be the processor 1003 of the control unit 1000 or comprised in the processor 1003 of the control unit 1000.

The compensation signal may be generated further based on the performance parameter from step 901.

The compensation signal may have at least one of:
a same frequency as a second type of frequency component of the motion signal; and/or
a fixed phase relationship to the motion signal; and/or
an amplitude which is at least substantially matches an amplitude of the motion signal.

The control unit 1000 may be arranged to, e.g. by means of a filtering unit 1008, filter the motion signal by removing a first type of frequency component and/or disturbances from the motion signal such that a second type of frequency component is maintained in the motion signal. The filtering unit 1008 may also be referred to as a filtering unit, a filtering means, a filtering circuit, means for filtering etc. The filtering unit 1008 may be the processor 1003 of the control unit 1000 or comprised in the processor 1003 of the control unit 1000. The filtering unit 1008 may be the filter 401 exemplified in FIGS. 4 and 7.

The first type of frequency component may be other frequency components, i.e. other than the dominant frequency component. The second type of frequency component may be the dominant frequency component.

The control unit 1000 may be arranged to, e.g. by means of a determining unit 1010, determine a time delay based on the motion signal. The determining unit 1010 may also be referred to as a determining unit, a determining means, a determining circuit, means for determining etc. The determining unit 1010 may be the processor 1003 of the control unit 1000 or comprised in the processor 1003 of the control unit 1000.

The control unit 1000 may be arranged to, e.g. by means of an adding unit 1012, add the time delay to the filtered motion signal. The compensation signal comprises the filtered motion signal with the added time delay. The adding unit 1012 may also be referred to as an adding unit, an adding means, an adding circuit, means for adding etc. The adding unit 1012 may be the processor 1003 of the control unit 1000 or comprised in the processor 1003 of the control unit 1000. The adding unit 1012 may be the delay unit 403 exemplified in FIGS. 4 and 7.

The control unit 1000 may be arranged to, e.g. by means of a performing unit 1015, perform a PLL procedure based on the motion signal to generate a phase-locked motion signal. The performing unit 1015 may also be referred to as a performing unit, a performing means, a performing circuit, means for performing etc. The performing unit 1015 may be the processor 1003 of the control unit 1000 or comprised in the processor 1003 of the control unit 1000. The performing unit 1015 may comprise the PLL unit 510 and/or the envelope detector unit 502 illustrated in FIG. 5 and FIG. 8.

The control unit 1000 may be arranged to, e.g. by means of the performing unit 1015, perform an envelope detection procedure based on the motion signal to generate an envelope motion signal. The compensation signal may be a combination 503 of the phase-locked motion signal and the envelope motion signal.

The control unit 1000 is arranged to, e.g. by means of a triggering unit 1018, trigger beamsteering of the antenna 105 using the compensation signal, thereby compensating the movement of the antenna 105, i.e. the rotational movement. The triggering unit 1018 may also be referred to as a triggering unit, a triggering means, a triggering circuit, means for triggering etc. The triggering unit 1015 may be the processor 1003 of the control unit 1000 or comprised in the processor 1003 of the control unit 1000.

The present mechanism for triggering beamsteering of the antenna 105 mounted to a mounting structure 113 may be implemented through one or more processors, such as a processor 1003 in the arrangement depicted in FIG. 10, together with computer program code for performing the functions described herein. The processor may be for example a Digital Signal Processor (DSP), Application Specific Integrated Circuit (ASIC) processor, Field-programmable gate array (FPGA) processor or microprocessor. The program code mentioned above may also be provided as a computer program product, for instance in the form of a data carrier carrying computer program code for performing the present disclosure herein when being loaded into the control unit 1000. One such carrier may be in the form of a CD ROM disc. It is however feasible with other data carriers such as a memory stick. The computer program code can be provided as pure program code on a server and downloaded to the control unit 1000.

The control unit 1000 may comprise a memory 1018 comprising one or more memory units. The memory 1018 is arranged to be used to store obtained information, store data, configurations, schedulings, and applications etc. to perform the methods herein when being executed in the control unit 1000.

The control unit 1000 may receive information from, e.g. the sensor 201, the antenna 105, the radio 110, another antenna, another radio etc., through a receiving port 1020. The receiving port 1020 may be, for example, connected to one or more antennas in control unit 1000. The control unit 1000 may receive information from another structure in the system 100 through the receiving port 1020. Since the receiving port 1020 may be in communication with the processor 1003, the receiving port 1020 may then send the received information to the processor 1003. The receiving port 1020 may also be configured to receive other information.

The processor 1003 in the control unit 1000 may be configured to transmit or send information to e.g. sensor 201, the antenna 105, the radio 110, another antenna, another radio or another structure in the system 100, through a sending port 1023, which may be in communication with the processor 1003, and the memory 1018.

The control unit 1000 may comprise the obtaining unit 1001, the generating unit 1005, the filtering unit 1008, the determining unit 1010, the adding unit 1012, the performing unit 1015 and other unit(s) 1025.

Those skilled in the art will also appreciate that the obtaining unit 1001, the generating unit 1005, the filtering unit 1008, the determining unit 1010, the adding unit 1012, the performing unit 1015 and other unit(s) 1025 described above may refer to a combination of analogue and digital circuits, and/or one or more processors configured with software and/or firmware, e.g., stored in memory, that, when executed by the one or more processors such as the processor 1001, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

The different units described above may be implemented as one or more applications running on one or more processors such as the processor 1003.

Thus, the methods described herein for the control unit 1000 may be respectively implemented by means of a computer program 1030 product, comprising instructions, i.e., software code portions, which, when executed on at least one processor 1003, cause the at least one processor 1003 to carry out the actions described herein, as performed by the control unit 1000. The computer program 1030 product may be stored on a computer-readable storage medium 1033. The computer-readable storage medium 1033, having stored thereon the computer program 1030, may comprise instructions which, when executed on at least one processor 1003, cause the at least one processor 1003 to carry out the actions described herein, as performed by the control unit 1000. The computer-readable storage medium 1033 may be a non-transitory computer-readable storage medium, such as a CD ROM disc, or a memory stick. The computer program 1030 product may be stored on a carrier containing the computer program 1030 just described, wherein the carrier is one of an electronic signal, optical signal, radio signal, or the first computer-readable storage medium 1033, as described above.

The control unit 1000 may comprise a communication interface configured to facilitate communications between the control unit 1000 and other control units or devices, e.g., the sensor 201, the radio 110, the antenna 105, another antenna, another radio, or another structure. The interface may comprise a transceiver configured to transmit and receive radio signals over an air interface in accordance with a suitable standard.

The antenna 105 comprises the control unit 1000 described above.

A computer program product comprises program code for performing, when executed by a processing circuitry, the method described herein, e.g. as exemplified in FIGS. 2-10. The processing circuitry may be the processor 1003 in FIG. 10, or it may comprise the processor 1003 in FIG. 10. The computer program product may be the computer program 1030 in FIG. 10 or comprise the computer program 1030 in FIG. 10.

A non-transitory computer-readable storage medium comprising instructions, which when executed by a processing circuitry, cause the processing circuitry to perform the method described herein, e.g. as exemplified in FIGS. 2-10. The non-transitory computer-readable storage medium may be the computer-readable medium 1033 in FIG. 10, or it may comprise the computer-readable medium 1033 in FIG. 10. The computer program product may be the computer program 1030 in FIG. 10 or comprise the computer program 1030 in FIG. 10.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

In general, the usage of “first”, “second”, “third”, “fourth”, and/or “fifth” herein may be understood to be an arbitrary way to denote different elements or entities, and may be understood to not confer a cumulative or chronological character to the nouns they modify, unless otherwise noted, based on context.

The present disclosure is not limited to the above. Various alternatives, modifications and equivalents may be used. Therefore, disclosure herein should not be taken as limiting the scope. A feature may be combined with one or more other features.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

The steps of the methods may be performed in another order than the order in which they appear herein.

1. A computer-implemented method performed by a control unit for triggering beamsteering of a radio communication antenna mounted to a mounting structure the method comprises:
obtaining a motion signal indicating movement of the antenna;
generating a compensation signal based on the motion signal, wherein the compensation signal is in-phase with the motion signal; and
triggering beamsteering of the radio communication antenna using the compensation signal, thereby compensating the movement of the antenna

2. The method according to claim 1, wherein generating, a compensation signal based on the motion signal comprises:
filtering the motion signal by removing a first type of frequency component and/or disturbances from the motion signal such that a second type of frequency component is maintained in the motion signal;
determining a time delay based on the motion signal; and
adding the time delay to the filtered motion signal;
wherein the compensation signal comprises the filtered motion signal with the added time delay.

3. The method according to claim 1, wherein generating a compensation signal based on the motion signal comprises:
performing a phase-locked loop procedure based on the motion signal to generate a phase-locked motion signal;
performing an envelope detection procedure based on the motion signal to generate an envelope motion signal; and
wherein the compensation signal is a combination of the phase-locked motion signal and the envelope motion signal.

4. The method according to claim 1, comprising:
obtaining performance parameter from a radio communication device associated with the radio communication antenna; and
wherein the compensation signal is generated further based on the performance parameter.

5. The method according to claim 4, wherein the performance parameter is a received power parameter.

6. The method according to claim 1, wherein the motion signal is obtained from at least one of an Internal Measurement Unit (IMU)
and/or a radio communication device associated with the radio communication antenna.

7. The method according claim 1, wherein the compensation signal has at least one of:
a same frequency as a second type of frequency component of the motion signal; and/or
a fixed phase relationship to the motion signal; and/or
an amplitude which is at least substantially matches an amplitude of the motion signal.

8. A control unit for triggering beamsteering of a radio communication antenna mounted to a mounting structure wherein the control unit is arranged to:
obtain a motion signal indicating movement of the antenna;
generate a compensation signal based on the motion signal, wherein the compensation signal is in-phase with the motion signal; and
trigger beamsteering of the radio communication antenna using the compensation signal, thereby compensating the movement of the antenna.

9. A radio communication antenna comprising the control unit of claim 8.

10. A computer program product comprising a non-transitory computer readable medium storing program code for performing, when executed by a processing circuitry, the method of claim 1.

11. (canceled)
